(19) United States
(12) Patent Application Publication
(10) Pub. No.: US 2024/0281648 A1
(43) Pub. Date: Aug. 22, 2024

(54) PERFORMING SEMANTIC MATCHING IN A DATA FABRIC USING ENRICHED METADATA

(71) Applicant: International Business Machines Corporation, Armonk, NY (US)

(72) Inventors: Balaji Ganesan, Bengaluru (IN); Muhammed Abdul Majeed Ameen, Kozhikode (IN); Aniket Saxena, Ghaziabad (IN); Arvind Agarwal, New Delhi (IN); Priyanka Telang, Bengaluru (IN); Soma Shekar Naganna, Bangalore (IN)

(21) Appl. No.: 18/111,379

(22) Filed: Feb. 17, 2023

(51) Int. Cl. G06N 3/08

(52) U.S. Cl. CPC G06N 3/08

(57) ABSTRACT

A computer-implemented method, system and computer program product for performing semantic matching in a data fabric. Knowledge graphs are populated with metadata enriched with master data. Based on such knowledge graphs with the metadata enriched with the master data, a trained multi-layer graph neural network generates embeddings. Furthermore, behavioral metadata from data stewards are monitored and collected. Such behavioral metadata may be used to enrich metadata, which are populated in knowledge graphs which are inputted into the multi-layer graph neural network to generate embeddings. Upon generating the embeddings discussed above, semantic matching of the data assets in the data fabric using the embeddings is performed. In this manner, semantic matching of the data assets in the data fabric is more effectively performed by utilizing master data and behavioral metadata.

### TECHNICAL FIELD

The present disclosure relates generally to a data fabric, and more particularly to performing semantic matching in a data fabric using metadata enriched from master data and behavioral metadata from data stewards.

### BACKGROUND

A data fabric is an architecture that facilitates the end-to-end integration of various data pipelines and cloud environments through the use of intelligent and automated systems. Over the last decade, developments within hybrid cloud, artificial intelligence, the Internet of Things (IoT), and edge computing have led to the exponential growth of big data, creating even more complexity for enterprises to manage. This has made the unification and governance of data environments an increasing priority as this growth has created significant challenges, such as data silos, security risks and general bottlenecks to decision making.

### SUMMARY

In one embodiment of the present disclosure, a computer-implemented method for performing semantic matching in a data fabric comprises accessing metadata and master data. The method further comprises enriching the metadata with the master data. The method additionally comprises populating knowledge graphs with the metadata enriched with the master data. Furthermore, the method comprises generating embeddings by a multi-layer graph neural network based on the knowledge graphs of the metadata enriched with the master data. Additionally, the method comprises performing semantic matching of data assets in the data fabric using the embeddings.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the data fabric system to perform semantic matching of the data assets in a data fabric using embeddings generated from the multi-layer graph neural network based on knowledge graphs populated with enriched metadata in accordance with an embodiment of the present disclosure;

FIG. 3 illustrates exemplary tabular master data which will be used to enrich the metadata and populate a knowledge graph in accordance with an embodiment of the present disclosure;

FIG. 4 illustrates knowledge graphs that are populated using the enriched metadata that includes the master data from the tables of FIG. 3 in accordance with an embodiment of the present disclosure;

FIG. 5 illustrates an embodiment of the present disclosure of the hardware configuration of the data fabric system which is representative of a hardware environment for practicing the present disclosure;

FIG. 6 is a flowchart of a method for training a multi-layer graph neural network to correctly process knowledge graphs containing enriched metadata in accordance with an embodiment of the present disclosure;

FIG. 7 is a flowchart of a method for enriching metadata with master data and behavioral metadata from data stewards used to generate embeddings in accordance with an embodiment of the present disclosure; and

FIG. 8 is a flowchart of a method for performing semantic matching of the data assets in the data fabric using the embeddings in accordance with an embodiment of the present disclosure.

### DETAILED DESCRIPTION

As stated above, a data fabric is an architecture that facilitates the end-to-end integration of various data pipelines and cloud environments through the use of intelligent and automated systems. Over the last decade, developments within hybrid cloud, artificial intelligence, the Internet of Things (IoT), and edge computing have led to the exponential growth of big data, creating even more complexity for enterprises to manage. This has made the unification and governance of data environments an increasing priority as this growth has created significant challenges, such as data silos, security risks and general bottlenecks to decision making.

Historically, an enterprise may have had different data platforms aligned to specific lines of business. For example, the enterprise may have a human resources data platform, a supply chain data platform and a customer data platform, which house data in different and separate environments despite potential overlaps. However, a data fabric may allow decision-makers to view this data more cohesively to better understand the customer lifecycle, make connections between data that did not previously exist, etc. By closing these gaps in the understanding of customers, products and processes, data fabrics are accelerating digital transformation and automation initiatives across businesses.

By leveraging data services and application programming interfaces (APIs), data fabrics pull together data from legacy systems, data lakes, data warehouses, SQL databases, and apps, providing a holistic view into business performance. In contrast to these individual data storage systems, it aims to create more fluidity across data environments, attempting to counteract the problem of data gravity, i.e., the idea that data becomes more difficult to move as it grows in size. A data fabric abstracts away the technological complexities engaged for data movement, transformation and integration, making all data available across the enterprise.

Data fabric architectures operate around the idea of loosely coupling data in platforms with applications that need it. One example of a data fabric architecture in a multi-cloud environment consists of a cloud platform (e.g., Amazon Web Services®) which manages data ingestion and another cloud platform (e.g., Azure®) which oversees data transformation and consumption. Another vendor, such as IBM Cloud Pak®, may provide the analytical services. The data fabric architecture stitches these environments together to create a unified view of data.

Data fabric architectures typically include a data management layer (responsible for data governance and security of data), a data ingestion layer (stitches cloud data together and finds connections between structured and unstructured data), a data processing layer (refines the data to ensure that only relevant data is surfaced for data extraction), a data orchestration layer (transforms, integrates and cleanses the data to make it usable for teams across the business), a data discovery layer (integrates disparate data sources) and a data access layer (allows for the consumption of data and ensuring relevant data is surfaced through the use of dashboards and other visualization tools).

In order to unify data across various data types and endpoints, data fabric architectures may perform semantic matching using a knowledge graph. A knowledge graph represents a network of real-world entities (i.e., objects, events, situations or concepts) and illustrates the relationship between them. This information is usually stored in a graph database and visualized as a graph structure, prompting the term knowledge “graph.”

Semantic matching is a technique used to identify information which is semantically related, such as different data assets. Given any two graph-like structures (e.g., classifications, taxonomies database or XML schemas and ontologies), such as knowledge graphs, matching is an operator which identifies those nodes in the two structures which semantically correspond to one another. For example, applied to file systems, semantic matching may identify that a folder labeled “car” is semantically equivalent to another folder labeled “automobile” because they are synonyms in the English language.

Currently, such knowledge graphs are based solely on metadata (data that describes and gives information about other data) as opposed to the data itself, such as master data. Master data has not been utilized in knowledge graphs because is it too large to store in knowledge graphs. Master data is the core data that is essential for running operations, such as within a business enterprise or unit. Master data may include data about key business entities that provides context for business transactions and operations.

By not utilizing master data in its knowledge graphs, data fabric architectures may not be effectively performing semantic matching in the data fabric.

The embodiments of the present disclosure provide a means for performing semantic matching of the data assets in a data fabric using embeddings that were generated by a multi-layer graph neural network based on knowledge graphs populated with enriched metadata. “Enriched metadata,” as used herein, refers to metadata, such as the metadata of the data assets, which has been increased in quantity and quality with additional metadata from different sources. For example, the enriched metadata includes pre-existing metadata, such as the metadata of the data assets, as well as the additional metadata that was added to the pre-existing metadata. Such enriched metadata may then be represented in heterogenous knowledge graphs. In one embodiment, the pre-existing metadata may be enriched with master data (i.e., additional metadata is added to the pre-existing metadata based on master data), where such enriched metadata populates knowledge graphs, which is used is used by a multi-layer graph neural network to generate embeddings. “Embeddings,” as used herein, correspond to vector representations of a node's data and its knowledge of other nodes in the knowledge graphs. Furthermore, in one embodiment, the pre-existing metadata may be enriched with behavioral metadata from the data stewards. A data steward is an oversight or data governance role within an organization and is responsible for ensuring the quality and fitness for purpose of the organization's data assets, including the metadata for those data assets. In one embodiment, the collected behavioral metadata from the data stewards is used to enrich the metadata (the pre-existing metadata), where such enriched metadata is used to populate knowledge graphs. Embeddings may then be generated by the multi-layer graph neural network based on such knowledge graphs. The embeddings discussed above may then be utilized to perform semantic matching of the data assets in the data fabric. In this manner, master data as well as behavioral metadata may also be utilized to more effectively perform semantic matching in the data fabric. A further discussion regarding these and other features is provided below.

In some embodiments of the present disclosure, the present disclosure comprises a computer-implemented method, system and computer program product for performing semantic matching in a data fabric. In one embodiment of the present disclosure, knowledge graphs are populated with metadata enriched with master data. A “knowledge graph,” as used herein, represents a network of real-world entities (i.e., objects, events, situations or concepts) and illustrates the relationship between them. In one embodiment, such knowledge graphs are populated with enriched metadata (pre-existing metadata of the data assets enriched with master data) by utilizing natural language processing to construct a comprehensive view of nodes, edges and labels through a process called semantic enrichment. In one embodiment, such knowledge graphs are heterogenous knowledge graphs, whose nodes and edges have semantic types. Any object, place or person as well as their attributes can be a node. An edge defines the relationship between the nodes. Semantic enrichment is the process of adding a layer of topical metadata to content to make sense of the content (master data) and build connections to it. Based on such knowledge graphs of enriched metadata (pre-existing metadata of the data assets enriched with master data), a trained multi-layer graph neural network generates embeddings. In one embodiment, the multi-layer graph neural network is trained to perform graph and node classification, link prediction, etc., based on inputted knowledge graphs. Furthermore, in one embodiment, behavioral metadata from data stewards are monitored and collected. “Behavioral metadata,” as used herein, refers to historical data concerning the actions and knowledge of data stewards. For example, a data steward may use a specific algorithm for matching zip codes or identifying important columns in a table. Such a specific algorithm corresponds to the behavioral metadata of the data steward. A “data steward,” as used herein, is an oversight or data governance role within an organization and is responsible for ensuring the quality and fitness for purpose of the organization's data assets, including the metadata for those data assets. Such behavioral metadata may be used to enrich metadata, which are populated in knowledge graphs which are inputted into the multi-layer graph neural network to generate embeddings as discussed above. Such embeddings correspond to vector representations of a node's data and its knowledge of other nodes in the knowledge graphs. Such vector representations capture the graph topology, relationships between nodes and further relevant information, such as the properties of the nodes (e.g., person, location). Upon generating the embeddings discussed above, semantic matching of the data assets in the data fabric using the embeddings is performed. “Semantic matching,” as used herein, refers to a technique used to identify information which is semantically related, such as different data assets. In one embodiment, IBM® Match 360 is utilized to perform such semantic matching. In this manner, semantic matching of the data assets in the data fabric is more effectively performed by utilizing master data and behavioral metadata.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

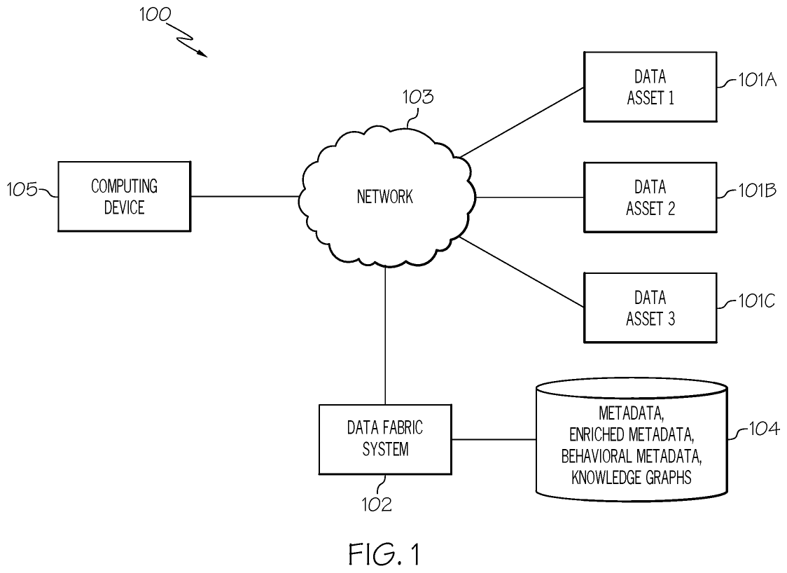

Referring now to the Figures in detail, FIG. 1 illustrates an embodiment of the present disclosure of a communication system 100 for practicing the principles of the present disclosure. Communication system 100 includes data assets 101A-101C (identified as “Data Asset 1,” “Data Asset 2,” and “Data Asset 3,” respectively, in FIG. 1) connected to a data fabric system 102 via a network 103. Data assets 101A-101C may collectively or individually be referred to as data assets 101 or data asset 101, respectively.

Data assets 101, as used herein, refer to data artefacts, such as databases, documents, videos, pictures, presentations, spreadsheets, emails, websites, etc., that carry data which is relevant for the value chain of an organization or institution, or which has strategic or operative value. In one embodiment, data assets 101 include tables in a database or datasets in a data catalog. In one embodiment, data assets 101 are located in a data fabric, which as discussed above, refers to the architecture that facilitates the end-to-end integration of various data pipelines and cloud environments through the use of intelligent and automated systems. In one embodiment, the data artefacts of data assets 101 are formed from disparate sources.

Data fabric system 102 is configured to establish a data fabric architecture that facilitates the end-to-end integration of various data pipelines and cloud environments through the use of intelligent and automated systems. In one embodiment, such a data fabric architecture includes a data management layer (responsible for data governance and security of data), a data ingestion layer (stitches cloud data together and finds connections between structured and unstructured data), a data processing layer (refines the data to ensure that only relevant data is surfaced for data extraction), a data orchestration layer (transforms, integrates and cleanses the data to make it usable for teams across the business), a data discovery layer (integrates disparate data sources) and a data access layer (allows for the consumption of data and ensuring relevant data is surfaced through the use of dashboards and other visualization tools).

In one embodiment, data fabric system 102 is configured to perform semantic matching in the data fabric architecture established by data fabric system 102. “Semantic matching,” as used herein, refers to a technique used to identify information which is semantically related, such as different data assets 101. In one embodiment, data fabric system 102 performs semantic matching of data assets 101 using embeddings that are generated by a multi-layer graph neural network based on knowledge graphs. A “knowledge graph,” as used herein, represents a network of real-world entities (i.e., objects, events, situations or concepts) and illustrates the relationship between them. This information is usually stored in a graph database and visualized as a graph structure, prompting the term knowledge “graph.”

In one embodiment, data fabric system 102 generates such knowledge graphs using enriched metadata. “Enriched metadata,” as used herein, refers to metadata, such as the metadata of the data assets, which has been increased in quantity and quality with additional metadata from different sources. For example, the enriched metadata includes pre-existing metadata (e.g., author, date created, date modified, file size, etc.), such as the metadata of data assets 101, as well as the additional metadata (e.g., name, location, etc.) that was added to the pre-existing metadata. In one embodiment, such enriched metadata may then be represented in knowledge graphs, which are used by the multi-layer graph neural network to generate embeddings. In one embodiment, data fabric system 102 enriches the pre-existing metadata (e.g., metadata of data assets 101) with master data. “Master data,” as used herein, refers to the core data that is essential for running operations, such as within a business enterprise or unit. Master data may include data about key business entities that provides context for business transactions and operations.

In one embodiment, data fabric system 102 enriches the pre-existing metadata (e.g., metadata of data assets 101) with master data, where such enriched metadata is used to populate knowledge graphs, such as heterogenous knowledge graphs (whose nodes and edges have semantic types). A multi-layer graph neural network then generates embeddings based on such knowledge graphs populated with such enriched metadata (metadata of data assets 101 enriched with master data). “Embeddings,” as used herein, correspond to vector representations of a node's data and its knowledge of other nodes in the knowledge graphs. These embeddings may then be used by data fabric system 102 to perform semantic matching of data assets 101 in the data fabric.

Furthermore, in one embodiment, data fabric system 102 enriches the pre-existing metadata with behavioral metadata from the data stewards. “Behavioral metadata,” as used herein, refers to historical data concerning the actions and knowledge of data stewards. For example, a data steward may use a specific algorithm for matching zip codes or identifying important columns in a table. Such a specific algorithm corresponds to the behavioral metadata of the data steward. A “data steward,” as used herein, is an oversight or data governance role within an organization and is responsible for ensuring the quality and fitness for purpose of the organization's data assets, including the metadata for those data assets. In one embodiment, data fabric system 102 enriches the pre-existing metadata (e.g., metadata of data assets 101) with the collected behavioral metadata from the data stewards, where such enriched metadata is used to populate knowledge graphs as well as metadata stores. Embeddings may then be generated by the multi-layer graph neural network based on such knowledge graphs, where such embeddings are used by data fabric system 102 to perform semantic matching of data assets 101 in the data fabric.

As a result of the multi-layer graph neural network generating embeddings based on knowledge graphs populated with enriched metadata, which includes master data and behavioral metadata, data fabric system 102 more effectively performs semantic matching of data assets 101 in the data fabric based on such embeddings.

In one embodiment, the knowledge graphs populated with the enriched metadata discussed above correspond to metadata knowledge graphs. A metadata knowledge graph shows how data is interconnected and provides information about hubs and pathways through which data flows and connects in the enterprise. In one embodiment, the metadata knowledge graph is built by scanning and cataloging the metadata, including the enriched metadata, with an enterprise data catalog.

In one embodiment, the understanding of the metadata, including the enriched metadata, is enhanced using a variety of artificial intelligence and machine learning techniques. In one embodiment, an artificial-intelligence powered enterprise data catalog, such as IBM Watson® Knowledge Catalog, automatically infers data domains and recommend similar datasets. In one embodiment, entities are identified and classified across structured and unstructured data, similar columns across data sources are identified, relationships between datasets are discovered, etc. In one embodiment, such features are performed using IBM® Match 360.

In one embodiment, business context is overlaid to the metadata. In one embodiment, an intelligent data catalog relates the business glossary terms to the technical metadata. Furthermore, in one embodiment, polices and processes from data governance tools may be incorporated. In one embodiment, such features are performed using IBM® Match 360.

Furthermore, as shown in FIG. 1, data fabric system 102 is connected to a data storage unit 104 (e.g., database) used to store metadata (also referred to herein as the “pre-existing metadata”), enriched metadata, master data, behavioral metadata and knowledge graphs.

A further discussion regarding these and other features of data fabric system 102 is provided below.

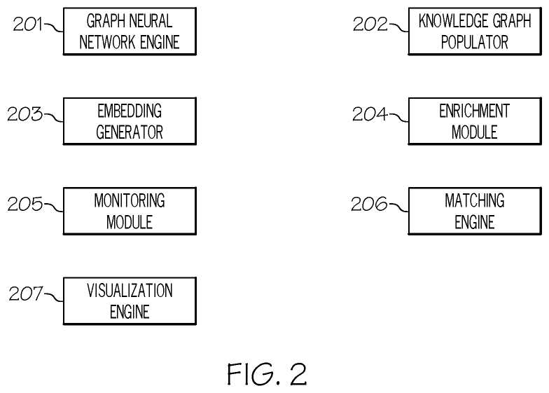

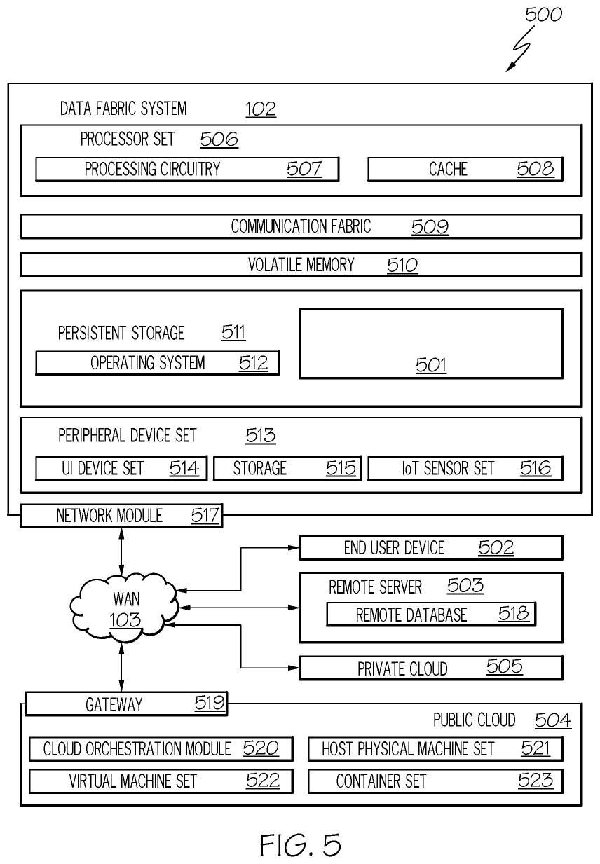

A description of the software components of data fabric system 102 used for performing semantic matching of data assets 101 in a data fabric using embeddings generated from the multi-layer graph neural network based on knowledge graphs populated with enriched metadata is provided below in connection with FIG. 2. A description of the hardware configuration of data fabric system 102 is provided further below in connection with FIG. 5.

Furthermore, as shown in FIG. 1, a computing device 105 of the data steward is connected to data fabric system 102 via network 103. As previously discussed, data fabric system 102 enriches the pre-existing metadata with behavioral metadata from the data stewards. A “data steward,” as used herein, is an oversight or data governance role within an organization and is responsible for ensuring the quality and fitness for purpose of the organization's data assets, including the metadata for those data assets. Computing device 105 of the data steward may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 105 and data fabric system 102. It is noted that both computing device 105 and the user (data steward) of computing device 105 may be identified with element number 105.

System 100 is not to be limited in scope to any one particular network architecture. System 100 may include any number of data assets 101, data fabric systems 102, networks 103, data storage units 104 and computing devices 105.

A discussion regarding the software components used by data fabric system 102 to perform semantic matching of data assets 101 in a data fabric using embeddings generated from the multi-layer graph neural network based on knowledge graphs populated with enriched metadata is provided below in connection with FIG. 2.

FIG. 2 is a diagram of the software components used by data fabric system 102 (FIG. 1) to perform semantic matching of data assets 101 in a data fabric using embeddings generated from the multi-layer graph neural network based on knowledge graphs populated with enriched metadata in accordance with an embodiment of the present disclosure.

As shown in FIG. 2, data fabric system 102 includes a graph neural network engine 201 configured to build and train a multi-layer graph neural network (e.g., graph convolutional network, graph auto-encoder network, recurrent graph neural network, gated graph neural network, etc.) to correctly process knowledge graphs containing embedded metadata, such as enriched metadata.

In one embodiment, graph neural network engine 201 builds a multi-layer graph neural network (GNN), which includes an input layer, a GNN layer(s) and a multilayer perceptron (MLP) prediction layer(s).

The input layer defines the initial representation of graph data (knowledge graph), which becomes the input to the GNN layer(s). As a result, a feature representation is assigned to the nodes and edges of the graph.

The GNN layer encodes the information on the structure of the graph. Then, it exploits this information to update the initial representation of nodes and edges.

The MLP prediction layer performs a specific learning task, including a graph-related task, such as node classification, link prediction, etc., employing the encoded graph representation obtained as output from the GNN layer(s).

In one embodiment, the input layer embeds the input features of the nodes (and edges) to a d-dimensional vector of hidden features. In one embodiment, such a representation is obtained via a linear transformation (also known as projection).

In one embodiment, the GNN layer updates the d-dimensional representation of the nodes obtained from the input layer. In one embodiment, graph neural network engine 201 implements a recursive neighborhood diffusion in which each node feature is updated with the features of its neighbors. The neighbor features are passed to the target node as messages through the edges. As a consequence, the new representation of the node encodes and represents the local structure of the graph.

In one embodiment, there may be different GNN layers, each consisting of a type of aggregation, which is performed by exploiting the structure of the knowledge graph. In one embodiment, in the formulation of the GNN, such as the Vanilla Graph Convolutional Networks (GCNs), the aggregation/update is an isotropic operation (features of the neighbor nodes are considered in the same way). In one embodiment, architectures, such as the Graph Attention Network (GAT), introduce anisotropic operations, in which the contribution of each neighbor node in the aggregation is weighted according to its importance.

In one embodiment, the MLP prediction layer(s) is a feedforward artificial neural network that generates a set of outputs from a set of inputs. An MLP is characterized by several layers of input nodes connected as a directed graph between the input and output layers. MLP uses backpropogation for training the network. In one embodiment, the output of the MLP prediction layer(s) corresponds to an embedding representation (embeddings) of the nodes, which will be characterized by features that convey specific information.

In one embodiment, graph neural network engine 201 is configured to train the multi-layer graph neural network to predict nodes, edges and graph-related tasks so as to perform graph and node classification, link prediction, etc., which are used to generate the embeddings upon which semantic matching of data assets 101 in the data fabric is performed. Any object, place or person as well as their attributes can be a node. An edge defines the relationship between the nodes.

In one embodiment, graph neural network engine 201 trains the multi-layer graph neural network (e.g., graph convolutional network, graph auto-encoder network, recurrent graph neural network, gated graph neural network, etc.) to predict nodes, edges and graph-related tasks using training data consisting of knowledge graphs. In one embodiment, such graph-related tasks include link prediction (predicts the link between a pair of nodes in a graph). As discussed above, knowledge graphs represent a network of real-world entities (i.e., objects, events, situations or concepts) and illustrate the relationships between them. Such knowledge graphs of the training data represent metadata (data that describes and gives information about other data) which may have been created by an expert. In one embodiment, such knowledge graphs correspond to metadata knowledge graphs built by scanning and cataloging the metadata with an enterprise data catalog, such as IBM Watson® Knowledge Catalog.

In one embodiment, a machine learning algorithm of graph neural network engine 201 uses the training data to build the neural model (multi-layer graph neural network) to make predictions or decisions as to the predicted nodes, edges and graph-related tasks based on the training data (knowledge graphs). The machine learning algorithm iteratively makes predictions on the training data such as the predicted nodes, edges and graph-related tasks until the predictions achieve the desired accuracy as determined by an expert. Examples of such machine learning algorithms include nearest neighbor, Naïve Bayes, decision trees, linear regression and support vector machines.

Once the multi-layer graph neural network has been trained to predict nodes, edges and graph-related tasks based on knowledge graphs, the trained multi-layer graph neural network may be utilized to generate embeddings (vector representations of a node's data and its knowledge of other nodes in the knowledge graphs) based on master data as well as based on behavioral metadata.

In one embodiment, such embeddings may be used by data fabric system 102 to perform semantic matching of data assets 101 in the data fabric as discussed further below.

Data fabric system 102 further includes a knowledge graph populator 202 configured to populate knowledge graphs, such as heterogenous knowledge graphs, with enriched metadata. In one embodiment, such enriched metadata includes the pre-existing metadata from data assets 101 that is enriched by adding master data to the pre-existing metadata. In one embodiment, knowledge graph populator 202 obtains metadata (pre-existing metadata of data assets 101) and master data, such as from data storage unit 104. As discussed above, master data refers to the core data that is essential for running operations, such as within a business enterprise or unit. For example, master data may include data about key business entities that provides context for business transactions and operations.

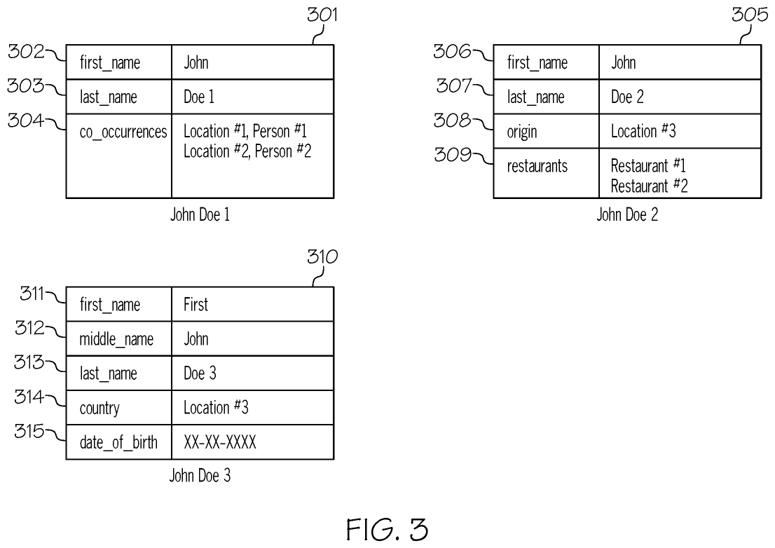

In one embodiment, master data is accessed from data storage unit 104, which is stored in tabular form. Such tabular master data may be from multiple sources. An example of master data being in tabular form is shown in FIG. 3.

Referring to FIG. 3, FIG. 3 illustrates exemplary tabular master data which will be used to enrich the metadata and populate a knowledge graph in accordance with an embodiment of the present disclosure.

As shown in FIG. 3, master data may be in the form of tables from multiple sources. For example, table 301 (from a first source) may include the first name (first_name) 302, last name (last_name) 303 and co-occurrences 304 for an individual.

Furthermore, as shown in FIG. 3, table 305 (from a second source) may include the first name (first_name) 306, last name (last_name) 307, origin 308 and restaurants 309 for an individual.

Additionally, as shown in FIG. 3, table 310 (from a third source) may include the first name (first_name) 311, middle name (middle_name) 312, last name (last_name) 313, country 314 and date of birth (date_of_birth) 315 for an individual.

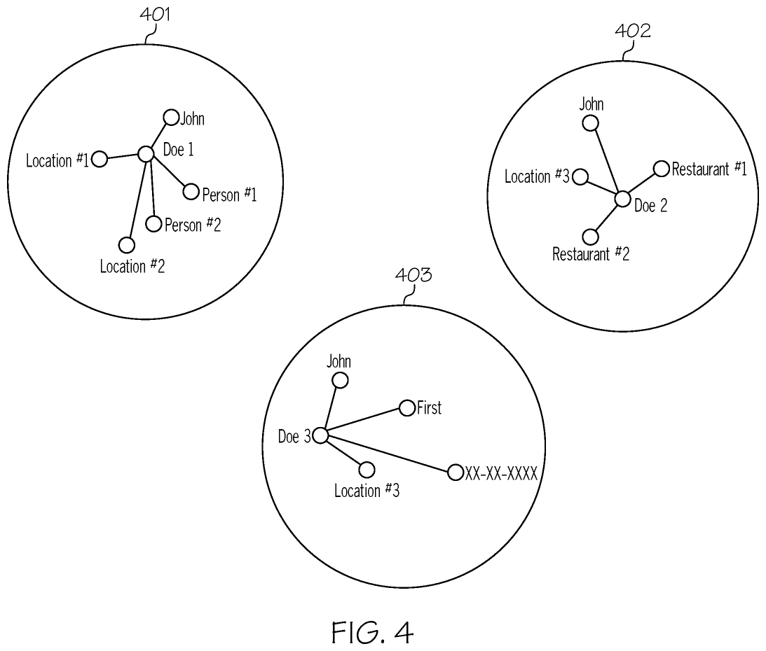

Such information stored in tables 301, 305, 310 corresponds to the master data which is used to enrich the metadata (pre-existing metadata of data assets 101), which is used to populate knowledge graphs as shown in FIG. 4.

FIG. 4 illustrates knowledge graphs that are populated using the enriched metadata that includes the master data from the tables of FIG. 3 in accordance with an embodiment of the present disclosure.

As shown in FIG. 4, knowledge graph 401 is populated with the master data from table 301. Furthermore, as shown in FIG. 4, knowledge graph 402 is populated with the master data from table 305. Additionally, as shown in FIG. 4, knowledge graph 403 is populated with the master data from table 310.

In one embodiment, such knowledge graphs 401, 402, 403 are populated with the master data from tables 301, 305, 310, respectively, by knowledge graph populator 202 utilizing natural language processing to construct a comprehensive view of nodes, edges and labels through a process called semantic enrichment. Any object, place or person as well as their attributes can be a node. An edge defines the relationship between the nodes. Semantic enrichment is the process of adding a layer of topical metadata to content to make sense of the content (master data) and build connections to it which may be performed by knowledge graph populator 202 using IBM Watson®.

In one embodiment, the knowledge graphs populated with enriched master data correspond to heterogeneous knowledge graphs in which the nodes and edges have semantic types, where the semantic types are assigned to different types of nodes (e.g., name, location) and relations to represent detailed information about the nodes and relations.

In one embodiment, such populated knowledge graphs are stored in data storage unit 104.

Returning to FIG. 2, in one embodiment, when data is ingested by knowledge graph populator 202, the semantic enrichment process allows knowledge graphs to identify individual objects and understand the relationships between different objects. This working knowledge is then compared and integrated with other datasets, which are relevant and similar in nature. In one embodiment, such features are implemented by knowledge graph populator 202 using IBM Watson®.

Data fabric system 102 further includes an embedding generator 203 configured to generate embeddings by the trained multi-layer graph neural network based on the knowledge graphs of the enriched metadata (pre-existing metadata enriched with master data) discussed above.

As previously discussed, the multi-layer graph neural network is trained to predict nodes, edges and graph-related tasks so as to perform graph and node classification, link prediction, etc., based on inputted knowledge graphs. In one embodiment, embedding generator 203 inputs the knowledge graphs of the enriched metadata (e.g., metadata enriched with master data) to the trained multi-layer graph neural network, which generates “embeddings,” which correspond to vector representations of a node's data and its knowledge of other nodes in the knowledge graphs.

Data fabric system 102 additionally includes a monitoring module 204 configured to monitor and collect behavioral metadata from data stewards. As discussed above, “behavioral metadata,” as used herein, refers to historical data concerning the actions and knowledge of data stewards. For example, a data steward may use a specific algorithm for matching zip codes or identifying important columns in a table. Such a specific algorithm corresponds to the behavioral metadata of the data steward. A “data steward,” as used herein, is an oversight or data governance role within an organization and is responsible for ensuring the quality and fitness for purpose of the organization's data assets, including the metadata for those data assets.

In one embodiment, monitoring module 204 monitors and collects behavioral metadata from data stewards by monitoring the actions of the data steward of computing device 105 via various software tools, including, but not limited to, Teramind®, Arcon®, Revenera®, ResarchMonitor, ActivTrak®, etc. Such actions may be performed based on the knowledge of data stewards, such as the user of computing device 105. In this manner, behavioral metadata may be obtained, such as selecting a specific algorithm for matching zip codes, etc.

In one embodiment, such collected behavioral metadata is stored in data storage unit 104.

Upon collecting such behavioral metadata, such collected behavioral metadata is used to enrich the metadata (pre-existing metadata from data assets 101) by knowledge graph populator 202 using the process discussed above.

After knowledge graph populator 202 populates the knowledge graphs with enriched metadata, which includes the collected behavioral metadata, embedding generator 203 generates embeddings by the multi-layer graph neural network based on the knowledge graphs (knowledge graphs of the enriched metadata containing the collected behavioral metadata) using the process discussed above.

Such embeddings may then be used by data fabric system 102 to perform semantic matching of data assets 101 in the data fabric as discussed further below.

In this manner, master data as well as behavioral metadata may be utilized to enrich the pre-existing metadata (e.g., metadata of data assets 101), which is represented in knowledge graphs by knowledge graph populator 202 using the process of populating knowledge graphs as discussed above. Such knowledge graphs may then be utilized by the multi-layer graph neural network to generate embeddings, which are used to perform semantic matching of data assets 101 in the data fabric as discussed below.

As also shown in FIG. 2, data fabric system 102 includes a matching engine 205 configured to perform semantic matching of data assets 101 in the data fabric using the embeddings. As discussed above, “semantic matching,” as used herein, refers to a technique used to identify information which is semantically related, such as different data assets 101. In one embodiment, matching engine 205 utilizes IBM® Match 360 to perform such semantic matching using the embeddings.

In one embodiment, IBM® Match 360 utilizes various matching algorithms based on the entity type of the associated data.

In one embodiment, matching engine 205 utilizes standardization, bucketing and comparison. During standardization, IBM® Match 360 standardizes the format of the data so that it can be processed by matching engine 205.

With respect to bucketing, IBM® Match 360 sorts data into various categories or “buckets” so that it can compare like-to-like pieces of information.

With respect to comparison, IBM® Match 360 compares data to determine a final comparison score. IBM® Match 360 then uses the comparison score to determine whether the records are a match.

In one embodiment, matching engine 205 calculates edit distance as one of the internal functions during comparison and matching of various attributes. Edit distance is a measurement of how dissimilar two strings are from each other. It is calculated by counting the number of changes required to transform one string into the other.

In one embodiment, there are different ways to define edit distance by using different sets of string operations. By default, in one embodiment, IBM® Match 360 uses a standard edit distance function.

In one embodiment, matching engine 205 performs 3 types of semantic matching using the embeddings, such as column matching, concept matching and entity matching. “Column matching,” as used herein, refers to identifying columns in different collections within the same source (e.g., data asset 101A) that are semantically related. “Concept matching,” as used herein, refers to identifying columns in different sources (e.g., data assets 101A, 101B) that are semantically related. “Entity matching,” as used herein, refers to identifying rows in the data (e.g., tabular data) stored in different collections (as well as possibly in different sources) that are semantically related.

Furthermore, as shown in FIG. 2, data fabric system 102 includes a visualization engine 206 configured to visualize the results of performing the semantic matching of data assets 101 in the data fabric. In one embodiment, visualization engine 206 utilizes IBM® Customer 360 which provides a 360 degree view of the results of preforming the semantic matching of data assets 101 in the data fabric using the embeddings.

A further description of these and other features is provided below in connection with the discussion of the method for performing semantic matching of the data assets in a data fabric using the embeddings that were generated by the multi-layer graph neural network based on knowledge graphs populated with metadata enriched with master data and behavioral metadata from data stewards.

Prior to the discussion of the method for performing semantic matching of the data assets in a data fabric using the embeddings that were generated by the multi-layer graph neural network based on knowledge graphs populated with metadata enriched with master data and behavioral metadata from data stewards, a description of the hardware configuration of data fabric system 102 (FIG. 1) is provided below in connection with FIG. 5.

Referring now to FIG. 5, in conjunction with FIG. 1, FIG. 5 illustrates an embodiment of the present disclosure of the hardware configuration of data fabric system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the disclosed methods, such as performing semantic matching of the data assets in a data fabric using the embeddings that were generated by the multi-layer graph neural network based on knowledge graphs populated with metadata enriched with master data and behavioral metadata from data stewards. In addition to block 501, computing environment 500 includes, for example, data fabric system 102, network 103, such as a wide area network (WAN), end user device (EUD) 502, remote server 503, public cloud 504, and private cloud 505. In this embodiment, data fabric system 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IOT) sensor set 516), and network module 517. Remote server 503 includes remote database 518. Public cloud 504 includes gateway 519, cloud orchestration module 520, host physical machine set 521, virtual machine set 522, and container set 523.

Data fabric system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically data fabric system 102, to keep the presentation as simple as possible. Data fabric system 102 may be located in a cloud, even though it is not shown in a cloud in FIG. 5. On the other hand, data fabric system 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto data fabric system 102 to cause a series of operational steps to be performed by processor set 506 of data fabric system 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 508 and the other storage media discussed below. The program instructions, and associated data, are accessed by processor set 506 to control and direct performance of the disclosed methods. In computing environment 500, at least some of the instructions for performing the disclosed methods may be stored in block 501 in persistent storage 511.

Communication fabric 509 is the signal conduction paths that allow the various components of data fabric system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In data fabric system 102, the volatile memory 510 is located in a single package and is internal to data fabric system 102, but, alternatively or additionally, the volatile memory may be distributed over multiple packages and/or located externally with respect to data fabric system 102.

Persistent Storage 511 is any form of non-volatile storage for computers that is now known or to be developed in the future. The non-volatility of this storage means that the stored data is maintained regardless of whether power is being supplied to data fabric system 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the disclosed methods.

Peripheral device set 513 includes the set of peripheral devices of data fabric system 102. Data communication connections between the peripheral devices and the other components of data fabric system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where data fabric system 102 is required to have a large amount of storage (for example, where data fabric system 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows data fabric system 102 to communicate with other computers through WAN 103. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the disclosed methods can typically be downloaded to data fabric system 102 from an external computer or external storage device through a network adapter card or network interface included in network module 517.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates data fabric system 102), and may take any of the forms discussed above in connection with data fabric system 102. EUD 502 typically receives helpful and useful data from the operations of data fabric system 102. For example, in a hypothetical case where data fabric system 102 is designed to provide a recommendation to an end user, this recommendation would typically be communicated from network module 517 of data fabric system 102 through WAN 103 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to data fabric system 102. Remote server 503 may be controlled and used by the same entity that operates data fabric system 102. Remote server 503 represents the machine(s) that collect and store helpful and useful data for use by other computers, such as data fabric system 102. For example, in a hypothetical case where data fabric system 102 is designed and programmed to provide a recommendation based on historical data, then this historical data may be provided to data fabric system 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to perform semantic matching of the data assets in a data fabric using the embeddings that were generated by the multi-layer graph neural network based on knowledge graphs populated with metadata enriched with master data and behavioral metadata from data stewards. In one embodiment, such components may be implemented in hardware. The functions discussed above performed by such components are not generic computer functions. As a result, data fabric system 102 is a particular machine that is the result of implementing specific, non-generic computer functions.

In one embodiment, the functionality of such software components of data fabric system 102, including the functionality for performing semantic matching of the data assets in a data fabric using the embeddings that were generated by the multi-layer graph neural network based on knowledge graphs populated with metadata enriched with master data and behavioral metadata from data stewards may be embodied in an application specific integrated circuit.

As stated above, data fabric architectures operate around the idea of loosely coupling data in platforms with applications that need it. One example of a data fabric architecture in a multi-cloud environment consists of a cloud platform (e.g., Amazon Web Services®) which manages data ingestion and another cloud platform (e.g., Azure®) which oversees data transformation and consumption. Another vendor, such as IBM Cloud Pak®, may provide the analytical services. The data fabric architecture stitches these environments together to create a unified view of data. Data fabric architectures typically include a data management layer (responsible for data governance and security of data), a data ingestion layer (stitches cloud data together and finds connections between structured and unstructured data), a data processing layer (refines the data to ensure that only relevant data is surfaced for data extraction), a data orchestration layer (transforms, integrates and cleanses the data to make it usable for teams across the business), a data discovery layer (integrates disparate data sources) and a data access layer (allows for the consumption of data and ensuring relevant data is surfaced through the use of dashboards and other visualization tools). In order to unify data across various data types and endpoints, data fabric architectures may perform semantic matching using a knowledge graph. A knowledge graph represents a network of real-world entities (i.e., objects, events, situations or concepts) and illustrates the relationship between them. This information is usually stored in a graph database and visualized as a graph structure, prompting the term knowledge “graph.” Semantic matching is a technique used to identify information which is semantically related, such as different data assets. Given any two graph-like structures (e.g., classifications, taxonomies database or XML schemas and ontologies), such as knowledge graphs, matching is an operator which identifies those nodes in the two structures which semantically correspond to one another. For example, applied to file systems, semantic matching may identify that a folder labeled “car” is semantically equivalent to another folder labeled “automobile” because they are synonyms in the English language. Currently, such knowledge graphs are based solely on metadata (data that describes and gives information about other data) as opposed to the data itself, such as master data. Master data has not been utilized in knowledge graphs because is it too large to store in knowledge graphs. Master data is the core data that is essential for running operations, such as within a business enterprise or unit. Master data may include data about key business entities that provides context for business transactions and operations. By not utilizing master data in its knowledge graphs, data fabric architectures may not be effectively performing semantic matching in the data fabric.

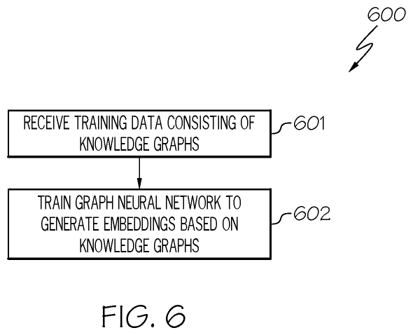

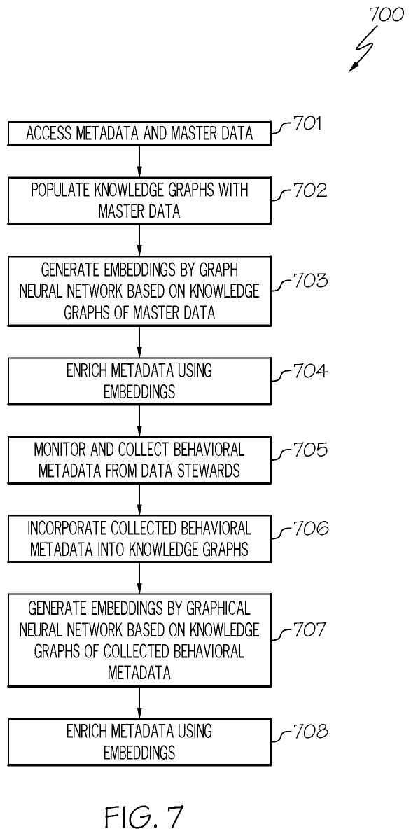

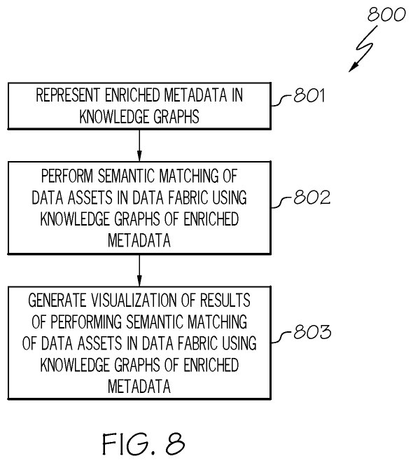

The embodiments of the present disclosure provide a means for performing semantic matching of the data assets in a data fabric using embeddings that were generated by a multi-layer graph neural network based on knowledge graphs populated with enriched metadata as discussed below in connection with FIGS. 6-8. FIG. 6 is a flowchart of a method for training a multi-layer graph neural network to correctly process knowledge graphs containing enriched metadata. FIG. 7 is a flowchart of a method for enriching metadata with master data and behavioral metadata from data stewards used to generate embeddings. FIG. 8 is a flowchart of a method for performing semantic matching of the data assets in the data fabric using the embeddings.

As stated above, FIG. 6 is a flowchart of a method 600 for training a multi-layer graph neural network to correctly process knowledge graphs containing enriched metadata in accordance with an embodiment of the present disclosure.

Referring to FIG. 6, in conjunction with FIGS. 1-5, in operation 601, graph neural network engine 201 of data fabric system 102 receives training data consisting of knowledge graphs.

As discussed above, knowledge graphs, as used herein, represent a network of real-world entities (i.e., objects, events, situations or concepts) and illustrate the relationships between them. Such knowledge graphs represent metadata (data that describes and gives information about other data) which may have been created by an expert. In one embodiment, such knowledge graphs correspond to metadata knowledge graphs built by scanning and cataloging the metadata with an enterprise data catalog, such as IBM Watson® Knowledge Catalog.

In operation 602, graph neural network engine 201 of data fabric system 102 trains a multi-layer graph neural network (e.g., graph convolutional network, graph auto-encoder network, recurrent graph neural network, gated graph neural network, etc.) to generate embeddings based on the training data.

As previously discussed, graph neural network engine 201 builds and trains a multi-layer graph neural network to correctly process knowledge graphs containing embedded metadata, such as enriched metadata.

In one embodiment, graph neural network engine 201 builds a multi-layer graph neural network (GNN), which includes an input layer, a GNN layer(s) and a multilayer perceptron (MLP) prediction layer(s).

In one embodiment, graph neural network engine 201 is configured to train the multi-layer graph neural network to predict nodes, edges and graph-related tasks so as to perform graph and node classification, link prediction, etc., which are used to generate the embeddings upon which semantic matching of data assets 101 in the data fabric is performed. Any object, place or person as well as their attributes can be a node. An edge defines the relationship between the nodes.

In one embodiment, graph neural network engine 201 trains the multi-layer graph neural network (e.g., graph convolutional network, graph auto-encoder network, recurrent graph neural network, gated graph neural network, etc.) to predict nodes, edges and graph-related tasks using training data consisting of knowledge graphs. In one embodiment, such graph-related tasks include link prediction (predicts the link between a pair of nodes in a graph). As discussed above, knowledge graphs represent a network of real-world entities (i.e., objects, events, situations or concepts) and illustrate the relationships between them. Such knowledge graphs of the training data represent metadata (data that describes and gives information about other data) which may have been created by an expert. In one embodiment, such knowledge graphs correspond to metadata knowledge graphs built by scanning and cataloging the metadata with an enterprise data catalog, such as IBM Watson® Knowledge Catalog.

In one embodiment, a machine learning algorithm of graph neural network engine 201 uses the training data to build the neural model (multi-layer graph neural network) to make predictions or decisions as to the predicted nodes, edges and graph-related tasks based on the training data (knowledge graphs). The machine learning algorithm iteratively makes predictions on the training data such as the predicted nodes, edges and graph-related tasks until the predictions achieve the desired accuracy as determined by an expert. Examples of such machine learning algorithms include nearest neighbor, Naïve Bayes, decision trees, linear regression and support vector machines.

Once the multi-layer graph neural network has been trained to predict nodes, edges and graph-related tasks based on knowledge graphs, the trained multi-layer graph neural network may be utilized to generate embeddings (vector representations of a node's data and its knowledge of other nodes in the knowledge graphs) based on master data as well as based on behavioral metadata as discussed further below in connection with FIG. 7.

FIG. 7 is a flowchart of a method 700 for enriching metadata with master data and behavioral metadata from data stewards used to generate embeddings in accordance with an embodiment of the present disclosure.

Referring to FIG. 7, in conjunction with FIGS. 1-6, in operation 701, knowledge graph populator 202 of data fabric system 102 accesses metadata and master data.

As stated above, knowledge graph populator 202 obtains metadata (pre-existing metadata of data assets 101) and master data, such as from data storage unit 104. As discussed above, master data refers to the core data that is essential for running operations, such as within a business enterprise or unit. For example, master data may include data about key business entities that provides context for business transactions and operations.

In operation 702, knowledge graph populator 202 of data fabric system 102 enriches the metadata (pre-existing metadata of data assets 101) with the master data.

As discussed above, in one embodiment, knowledge graph populator 202 enriches the pre- existing metadata from data assets 101 by adding master data to the pre-existing metadata.

In operation 703, knowledge graph populator 202 of data fabric system 102 populates knowledge graphs with the enriched metadata (metadata enriched with master data).

As stated above, in one embodiment, master data is accessed from data storage unit 104, which is stored in tabular form. Such tabular master data may be from multiple sources. An example of master data being in tabular form is shown in FIG. 3.

As shown in FIG. 3, master data may be in the form of tables from multiple sources. For example, table 301 (from a first source) may include the first name (first_name) 302, last name (last_name) 303 and co-occurrences 304 for an individual.

Furthermore, as shown in FIG. 3, table 305 (from a second source) may include the first name (first_name) 306, last name (last_name) 307, origin 308 and restaurants 309 for an individual.

Additionally, as shown in FIG. 3, table 310 (from a third source) may include the first name (first_name) 311, middle name (middle_name) 312, last name (last_name) 313, country 314 and date of birth (date_of_birth) 315 for an individual.

Such information stored in tables 301, 305, 310 corresponds to the master data which is used to enrich the metadata (pre-existing metadata of data assets 101), which is used to populate knowledge graphs as shown in FIG. 4.

As shown in FIG. 4, knowledge graph 401 is populated with the master data from table 301. Furthermore, as shown in FIG. 4, knowledge graph 402 is populated with the master data from table 305. Additionally, as shown in FIG. 4, knowledge graph 403 is populated with the master data from table 310.

In one embodiment, such knowledge graphs 401, 402, 403 are populated with the master data from tables 301, 305, 310, respectively, by knowledge graph populator 202 utilizing natural language processing to construct a comprehensive view of nodes, edges and labels through a process called semantic enrichment. Any object, place or person as well as their attributes can be a node. An edge defines the relationship between the nodes. Semantic enrichment is the process of adding a layer of topical metadata to content to make sense of the content (master data) and build connections to it which may be performed by knowledge graph populator 202 using IBM Watson®.

In one embodiment, the knowledge graphs populated with enriched master data correspond to heterogeneous knowledge graphs in which the nodes and edges have semantic types, where the semantic types are assigned to different types of nodes (e.g., name, location) and relations to represent detailed information about the nodes and relations.

In one embodiment, such populated knowledge graphs are stored in data storage unit 104.

In operation 704, embedding generator 203 of data fabric system 102 generates embeddings by the trained multi-layer graph neural network based on the knowledge graphs of the enriched metadata (metadata enriched with master data).

As previously discussed, the multi-layer graph neural network is trained to predict nodes, edges and graph-related tasks so as to perform graph and node classification, link prediction, etc., based on inputted knowledge graphs. In one embodiment, embedding generator 203 inputs the knowledge graphs of the enriched metadata (metadata enriched with master data) to the trained multi-layer graph neural network, which generates “embeddings,” which correspond to vector representations of a node's data and its knowledge of other nodes in the knowledge graphs.

In operation 705, monitoring module 204 of data fabric system 102 monitors and collects behavioral metadata from data stewards.

As discussed above, “behavioral metadata,” as used herein, refers to historical data concerning the actions and knowledge of data stewards. For example, a data steward may use a specific algorithm for matching zip codes or identifying important columns in a table. Such a specific algorithm corresponds to the behavioral metadata of the data steward. A “data steward,” as used herein, is an oversight or data governance role within an organization and is responsible for ensuring the quality and fitness for purpose of the organization's data assets, including the metadata for those data assets.

In one embodiment, monitoring module 204 monitors and collects behavioral metadata from data stewards by monitoring the actions of the data steward of computing device 105 via various software tools, including, but not limited to, Teramind®, Arcon®, Revenera®, ResarchMonitor, ActivTrak®, etc. Such actions may be performed based on the knowledge of data stewards, such as the user of computing device 105. In this manner, behavioral metadata may be obtained, such as selecting a specific algorithm for matching zip codes, etc.

In one embodiment, such collected behavioral metadata is stored in data storage unit 104.

In operation 706, knowledge graph populator 202 of data fabric system 102 enriches the metadata (pre-existing metadata of data assets 101) with the behavioral metadata.

As discussed above, upon collecting such behavioral metadata, knowledge graph populator 202 enriches the metadata (pre-existing metadata from data assets 101) using the collected behavioral metadata using the process discussed above in connection with operation 702.

In operation 707, knowledge graph populator 202 of data fabric system 102 populates knowledge graphs with the enriched metadata (metadata enriched with behavioral metadata) using the same process discussed above in connection with operation 703.

In one embodiment, such enriched metadata (metadata enriched with behavioral metadata) is stored in a metadata store.

In operation 708, embedding generator 203 of data fabric system 102 generates embeddings by the trained multi-layer graph neural network based on the knowledge graphs of the enriched metadata (metadata enriched with behavioral metadata) using the same process discussed above in connection with operation 704.

After generating embeddings by the trained multi-layer graph neural network based on the knowledge graphs of the enriched metadata, semantic matching of data assets 101 in the data fabric using the embeddings is performed as discussed below in connection with FIG. 8.

FIG. 8 is a flowchart of a method 800 for performing semantic matching of the data assets in the data fabric using the embeddings in accordance with an embodiment of the present disclosure.

Referring to FIG. 8, in conjunction with FIGS. 1-7, in operation 801, matching engine 205 of data fabric system 102 performs semantic matching of data assets 101 in the data fabric using the embeddings of operations 704, 708.

As discussed above, “semantic matching,” as used herein, refers to a technique used to identify information which is semantically related, such as different data assets 101. In one embodiment, matching engine 205 utilizes IBM® Match 360 to perform such semantic matching using the embeddings of operations 704, 708.

In one embodiment, IBM® Match 360 utilizes various matching algorithms based on the entity type of the associated data.

In one embodiment, matching engine 205 utilizes standardization, bucketing and comparison. During standardization, IBM® Match 360 standardizes the format of the data so that it can be processed by matching engine 205.

With respect to bucketing, IBM® Match 360 sorts data into various categories or “buckets” so that it can compare like-to-like pieces of information.

With respect to comparison, IBM® Match 360 compares data to determine a final comparison score. IBM® Match 360 then uses the comparison score to determine whether the records are a match.

In one embodiment, matching engine 205 calculates edit distance as one of the internal functions during comparison and matching of various attributes. Edit distance is a measurement of how dissimilar two strings are from each other. It is calculated by counting the number of changes required to transform one string into the other.

In one embodiment, there are different ways to define edit distance by using different sets of string operations. By default, in one embodiment, IBM® Match 360 uses a standard edit distance function.

In one embodiment, matching engine 205 performs 3 types of semantic matching using the embeddings, such as column matching, concept matching and entity matching. “Column matching,” as used herein, refers to identifying columns in different collections within the same source (e.g., data asset 101A) that are semantically related. “Concept matching,” as used herein, refers to identifying columns in different sources (e.g., data assets 101A, 101B) that are semantically related. “Entity matching,” as used herein, refers to identifying rows in the data (e.g., tabular data) stored in different collections (as well as possibly in different sources) that are semantically related.

In operation 802, visualization engine 206 of data fabric system 102 generates a visualization of the results of performing the semantic matching of data assets 101 in the data fabric in operation 801.

As stated above, in one embodiment, visualization engine 206 utilizes IBM® Customer 360 which provides a 360 degree view of the results of preforming the semantic matching of data assets 101 in the data fabric using the embeddings.

As a result of the foregoing, embodiments of the present disclosure provide a means for more effectively performing semantic matching of the data assets in a data fabric by using the embeddings generated by the multi-layer graph neural network based on knowledge graphs that include enriched metadata, where such enrichment of the metadata is from master data and behavioral metadata of the data stewards.

Furthermore, the principles of the present disclosure improve the technology or technical field involving a data fabric.

As discussed above, data fabric architectures operate around the idea of loosely coupling data in platforms with applications that need it. One example of a data fabric architecture in a multi-cloud environment consists of a cloud platform (e.g., Amazon Web Services®) which manages data ingestion and another cloud platform (e.g., Azure®) which oversees data transformation and consumption. Another vendor, such as IBM Cloud Pak®, may provide the analytical services. The data fabric architecture stitches these environments together to create a unified view of data. Data fabric architectures typically include a data management layer (responsible for data governance and security of data), a data ingestion layer (stitches cloud data together and finds connections between structured and unstructured data), a data processing layer (refines the data to ensure that only relevant data is surfaced for data extraction), a data orchestration layer (transforms, integrates and cleanses the data to make it usable for teams across the business), a data discovery layer (integrates disparate data sources) and a data access layer (allows for the consumption of data and ensuring relevant data is surfaced through the use of dashboards and other visualization tools). In order to unify data across various data types and endpoints, data fabric architectures may perform semantic matching using a knowledge graph. A knowledge graph represents a network of real-world entities (i.e., objects, events, situations or concepts) and illustrates the relationship between them. This information is usually stored in a graph database and visualized as a graph structure, prompting the term knowledge “graph.” Semantic matching is a technique used to identify information which is semantically related, such as different data assets. Given any two graph-like structures (e.g., classifications, taxonomies database or XML schemas and ontologies), such as knowledge graphs, matching is an operator which identifies those nodes in the two structures which semantically correspond to one another. For example, applied to file systems, semantic matching may identify that a folder labeled “car” is semantically equivalent to another folder labeled “automobile” because they are synonyms in the English language. Currently, such knowledge graphs are based solely on metadata (data that describes and gives information about other data) as opposed to the data itself, such as master data. Master data has not been utilized in knowledge graphs because is it too large to store in knowledge graphs. Master data is the core data that is essential for running operations, such as within a business enterprise or unit. Master data may include data about key business entities that provides context for business transactions and operations. By not utilizing master data in its knowledge graphs, data fabric architectures may not be effectively performing semantic matching in the data fabric.

Embodiments of the present disclosure improve such technology by populating knowledge graphs with metadata enriched with master data. A “knowledge graph,” as used herein, represents a network of real-world entities (i.e., objects, events, situations or concepts) and illustrates the relationship between them. In one embodiment, such knowledge graphs are populated with enriched metadata (pre-existing metadata of the data assets enriched with master data) by utilizing natural language processing to construct a comprehensive view of nodes, edges and labels through a process called semantic enrichment. In one embodiment, such knowledge graphs are heterogenous knowledge graphs, whose nodes and edges have semantic types. Any object, place or person as well as their attributes can be a node. An edge defines the relationship between the nodes. Semantic enrichment is the process of adding a layer of topical metadata to content to make sense of the content (master data) and build connections to it. Based on such knowledge graphs of enriched metadata (pre-existing metadata of the data assets enriched with master data), a trained multi-layer graph neural network generates embeddings. In one embodiment, the multi-layer graph neural network is trained to perform graph and node classification, link prediction, etc., based on inputted knowledge graphs. Furthermore, in one embodiment, behavioral metadata from data stewards are monitored and collected. “Behavioral metadata,” as used herein, refers to historical data concerning the actions and knowledge of data stewards. For example, a data steward may use a specific algorithm for matching zip codes or identifying important columns in a table. Such a specific algorithm corresponds to the behavioral metadata of the data steward. A “data steward,” as used herein, is an oversight or data governance role within an organization and is responsible for ensuring the quality and fitness for purpose of the organization's data assets, including the metadata for those data assets. Such behavioral metadata may be used to enrich metadata, which are populated in knowledge graphs which are inputted into the multi-layer graph neural network to generate embeddings as discussed above. Such embeddings correspond to vector representations of a node's data and its knowledge of other nodes in the knowledge graphs. Such vector representations capture the graph topology, relationships between nodes and further relevant information, such as the properties of the nodes (e.g., person, location). Upon generating the embeddings discussed above, semantic matching of the data assets in the data fabric using the embeddings is performed. “Semantic matching,” as used herein, refers to a technique used to identify information which is semantically related, such as different data assets. In one embodiment, IBM® Match 360 is utilized to perform such semantic matching. In this manner, semantic matching of the data assets in the data fabric is more effectively performed by utilizing master data and behavioral metadata. Furthermore, in this manner, there is an improvement in the technical field involving a data fabric.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for performing semantic matching in a data fabric, the method comprising:
accessing metadata and master data;
enriching the metadata with the master data;
populating knowledge graphs with the metadata enriched with the master data;
generating embeddings by a multi-layer graph neural network based on the knowledge graphs of the metadata enriched with the master data; and
performing semantic matching of data assets in the data fabric using the embeddings.

2. The method as recited in claim 1 further comprising:
monitoring and collecting behavioral metadata from data stewards;
enriching the metadata with the collected behavioral metadata;
populating knowledge graphs with the metadata enriched with the collected behavioral metadata; and
generating embeddings by the multi-layer graph neural network based on the knowledge graphs of the metadata enriched with the collected behavioral metadata.

3. The method as recited in claim 1 further comprising:
generating a visualization of results of the performing of the semantic matching of the data assets in the data fabric using the embeddings.

4. The method as recited in claim 1, wherein the data assets in the data fabric comprise tables in a database or datasets in a data catalog.

5. The method as recited in claim 1, wherein the semantic matching comprises one or more of the following in the group consisting of column matching, row matching and concept matching.

6. The method as recited in claim 1 further comprising:
receiving training data comprising knowledge graphs; and
training the multi-layer graph neural network to generate embeddings corresponding to vector representations of a node's data and its knowledge of other nodes in the knowledge graphs based on the training data.

7. The method as recited in claim 1, wherein the knowledge graphs populated with the metadata enriched with the master data comprise heterogenous knowledge graphs.

8. A computer program product for performing semantic matching in a data fabric, the computer program product comprising one or more computer readable storage mediums having program code embodied therewith, the program code comprising programming instructions for:
accessing metadata and master data;
enriching the metadata with the master data;
populating knowledge graphs with the metadata enriched with the master data;
generating embeddings by a multi-layer graph neural network based on the knowledge graphs of the metadata enriched with the master data; and
performing semantic matching of data assets in the data fabric using the embeddings.

9. The computer program product as recited in claim 8, wherein the program code further comprises the programming instructions for:
monitoring and collecting behavioral metadata from data stewards;
enriching the metadata with the collected behavioral metadata;
populating knowledge graphs with the metadata enriched with the collected behavioral metadata; and
generating embeddings by the multi-layer graph neural network based on the knowledge graphs of the metadata enriched with the collected behavioral metadata.

10. The computer program product as recited in claim 8, wherein the program code further comprises the programming instructions for:
generating a visualization of results of the performing of the semantic matching of the data assets in the data fabric using the embeddings.

11. The computer program product as recited in claim 8, wherein the data assets in the data fabric comprise tables in a database or datasets in a data catalog.

12. The computer program product as recited in claim 8, wherein the semantic matching comprises one or more of the following in the group consisting of column matching, row matching and concept matching.

13. The computer program product as recited in claim 8, wherein the program code further comprises the programming instructions for:
receiving training data comprising knowledge graphs; and
training the multi-layer graph neural network to generate embeddings corresponding to vector representations of a node's data and its knowledge of other nodes in the knowledge graphs based on the training data.

14. The computer program product as recited in claim 8, wherein the knowledge graphs populated with the metadata enriched with the master data comprise heterogenous knowledge 2 graphs.

15. A system, comprising:
a memory for storing a computer program for performing semantic matching in a data fabric; and
a processor connected to the memory, wherein the processor is configured to execute program instructions of the computer program comprising:
accessing metadata and master data;
enriching the metadata with the master data;
populating knowledge graphs with the metadata enriched with the master data;
generating embeddings by a multi-layer graph neural network based on the knowledge graphs of the metadata enriched with the master data; and 10
performing semantic matching of data assets in the data fabric using the embeddings.

16. The system as recited in claim 15, wherein the program instructions of the computer program further comprise:
monitoring and collecting behavioral metadata from data stewards;
enriching the metadata with the collected behavioral metadata;
populating knowledge graphs with the metadata enriched with the collected behavioral metadata; and
generating embeddings by the multi-layer graph neural network based on the knowledge graphs of the metadata enriched with the collected behavioral metadata.

17. The system as recited in claim 15, wherein the program instructions of the computer program further comprise:
generating a visualization of results of the performing of the semantic matching of the data assets in the data fabric using the embeddings.

18. The system as recited in claim 15, wherein the data assets in the data fabric comprise tables in a database or datasets in a data catalog.

19. The system as recited in claim 15, wherein the semantic matching comprises one or more of the following in the group consisting of column matching, row matching and concept matching.

20. The system as recited in claim 15, wherein the program instructions of the computer program further comprise:
receiving training data comprising knowledge graphs; and
training the multi-layer graph neural network to generate embeddings corresponding to vector representations of a node's data and its knowledge of other nodes in the knowledge graphs based on the training data.
